(19) United States
(12) Patent Application Publication
(10) Pub. No.: US 2025/0307288 A1
(43) Pub. Date: Oct. 2, 2025

(54) METHODS, SYSTEMS, AND APPARATUSES FOR SYNTACTIC SEMANTIC SEARCHING

(71) Applicant: THUMBTACK, INC., San Francisco, CA (US)

(72) Inventors: Karen Lo, San Francisco, CA (US); Tim Huang, San Francisco, CA (US); Navneet Rao, Sunnyvale, CA (US); Sophia Bussey, Pasadena, CA (US); Richard Demsyn-Jones, Toronto (CA); Abhilash Arora, Las Vegas, NV (US); Vishrut Arya, San Francisco, CA (US)

(21) Appl. No.: 19/095,915

(22) Filed: Mar. 31, 2025

Related U.S. Application Data
(60) Provisional application No. 63/572,102, filed on Mar. 29, 2024.

(51) Int. Cl. G06F 16/334; G06F 16/3332; G06F 40/30

(52) U.S. Cl. CPC G06F 16/3344; G06F 16/3334; G06F 40/30

(57) ABSTRACT

Systems and methods for providing recommended search terms using syntactic and semantic guidance are described herein. In one example, a method includes generating embeddings corresponding to search terms; detecting an initiation of a user query including one or more characters; performing a syntactic search including identifying prefix match results based on the characters included in the user query; determining that the user query exceeds a threshold length; and performing a semantic search. The semantic search includes generating at least one embedding for the user query and matching the embedding for the user query to a subset of the embeddings for the search terms, the subset of the embeddings corresponding to a subset of the search terms. The method also includes providing recommended search terms based on a ranking of the prefix match results and the subset of the search terms.

### CROSS-REFERENCE TO RELATED PATENT APPLICATIONS

This application claims the benefit of and priority to U.S. Provisional Patent Application No. 63/572,102, filed Mar. 29, 2024, which is incorporated herein by reference in its entirety and for all purposes.

### BACKGROUND

When entering a search query, a user may receive autocomplete suggestions based on the characters that the user has entered into the search bar thus far. The user may select one of the autocomplete suggestions based on the user's intent of the search query.

### SUMMARY

An embodiment relates to a computing system. The computing system includes a processing circuit having one or more processors coupled to one or more memory devices. The one or more memory devices store instructions thereon that, when executed by the one or more processors, cause the processing circuit to perform operations including generating, using a large language model, a plurality of embeddings corresponding to a plurality of search terms. The operations include detecting an initiation of a user query, where the user query includes one or more characters. The operations include performing a syntactic search, where the syntactic search includes identifying a plurality of prefix match results based on the one or more characters included in the user query. The operations include determining, in real-time with respect to the user query being entered, that the user query exceeds a threshold length. The operations include, in response to determining that the user query exceeds the threshold length, performing a semantic search. The semantic search includes generating at least one embedding for the user query. The semantic search includes matching the at least one embedding for the user query to a subset of the plurality of embeddings, where the subset of the plurality of embeddings correspond to a subset of the plurality of search terms. The operations include providing a plurality of recommended search terms, where the plurality of recommended search terms are provided based on a ranking of the plurality of prefix match results and the subset of the plurality of search terms.

Another embodiment relates to a method. The method includes generating, by a computing system using a large language model, a plurality of embeddings corresponding to a plurality of search terms. The method includes detecting, by the computing system, an initiation of a user query, where the user query includes one or more characters. The method includes performing, by the computing system, a syntactic search, where the syntactic search includes identifying a plurality of prefix match results based on the one or more characters included in the user query. The method includes determining, by the computing system and in real-time with respect to the user query being entered, that the user query exceeds a threshold length. The method includes, in response to determining that the user query exceeds the threshold length, performing, by the computing system, a semantic search. The semantic search includes generating at least one embedding for the user query. The semantic search includes matching the at least one embedding for the user query to a subset of the plurality of embeddings, where the subset of the plurality of embeddings correspond to a subset of the plurality of search terms. The method includes providing, by the computing system, a plurality of recommended search terms, where the plurality of recommended search terms are provided based on a ranking of the plurality of prefix match results and the subset of the plurality of search terms.

Another embodiment relates to a non-transitory computer-readable medium storing instructions that, when executed by a processor of a processing circuit, cause the processing circuit to generate, using a large language model, a plurality of embeddings corresponding to a plurality of search terms. The instructions cause the processing circuit to detect an initiation of a user query, where the user query includes one or more characters. The instructions cause the processing circuit to perform a syntactic search, where the syntactic search includes identifying a plurality of prefix match results based on the one or more characters included in the user query. The instructions cause the processing circuit to determine, in real-time with respect to the user query being entered, that the user query exceeds a threshold length. The instructions cause the processing circuit to, in response to determining that the user query exceeds the threshold length, perform a semantic search. The semantic search includes generating at least one embedding for the user query. The semantic search includes matching the at least one embedding for the user query to a subset of the plurality of embeddings, where the subset of the plurality of embeddings correspond to a subset of the plurality of search terms. The instructions cause the processing circuit to provide a plurality of recommended search terms, where the plurality of recommended search terms are provided based on a ranking of the plurality of prefix match results and the subset of the plurality of search terms.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a block diagram of a system for providing recommended search terms using syntactic and semantic guidance, according to an example embodiment.

FIG. 2 is an illustration of a user interface configured to present syntactic-based and semantic-based search query recommendations to a user, according to an example embodiment.

FIG. 3 is a flow chart illustrating a method for providing recommended search terms using syntactic and semantic guidance, according to an example embodiment.

FIG. 4 is a flow chart illustrating the method of FIG. 2 in greater detail, according to an example embodiment.

### DETAILED DESCRIPTION

In existing search systems, search bar autosuggestions are primarily focused on text matching. That is, when a user types in their query, prefix-matching algorithms are used to find search terms that start with or include the same letters that the user typed in their query. In some instances, such a lexical search may be sufficient for predicting what the user wants to type. However, in some instances, the resulting suggestions of these searches may not be what the user needs. In other words, there may be a disconnect between how the user formulates their problem in the search query and how a potential solution is formulated.

The technical solutions described herein improve generation of search suggestions by providing both semantic-based and syntactic-based suggestions. While syntactic search methods are heavily biased based on the exact terms in the raw query that a user types in, semantic search methods may allow users to type queries in natural language such that the search software is configured to understand the meaning behind the raw query. For example, syntactic searching may be less beneficial than semantic searching because generic terms included in a user query can result in inaccurate search results using semantic searching alone. At the same time, where queries include incomplete words or character counts below a threshold, syntactic searching may be more beneficial than semantic searching. The systems and methods described herein, however, are configured to provide syntactic and semantic search results by using a merging algorithm to obtain accurate search terms and corresponding search results that improve user searching capabilities beyond the capabilities provided merely by using only one of syntactic or semantic searching without the other.

The systems described herein provide the technical benefits of reducing consumption of processing power by performing various processing operations simultaneously (e.g., both syntactic and semantic searching processes), rather than performing a plurality of processing operations individually. Further, the systems described herein can determine whether to perform certain functions based on various data, and therefore can further reduce power consumption by not performing functions that are not necessary for the current task. For example, by using both syntactic and semantic search processes to identify suggested search terms, and then using a merge algorithm to combine the results of the separate search processes together before providing the merged results to the user, the systems and methods disclosed herein reduce the likelihood of presenting irrelevant search terms to the user, and more quickly identify relevant search terms, thereby also improving the efficiency of the search and reducing the likelihood of the user conducting additional searches to identify relevant search terms. Furthermore, the systems described herein can receive and analyze data and update stored data accordingly to dynamically enhance the suggestions provided to users. That is, the systems and methods described herein result in more efficient model development and improved model performance.

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

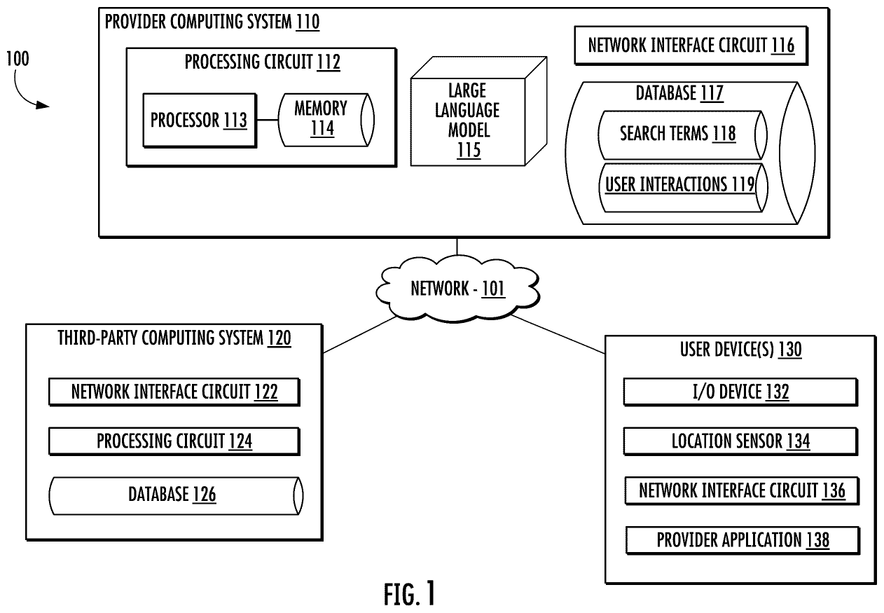

FIG. 1 is a diagram of a computing environment 100 for providing recommended search terms or search terms using syntactic and semantic guidance, according to an example embodiment. As shown, the computing environment 100 can include at least one provider computing system 110, at least one third-party computing system 120, and at least one user device 130. The provider computing system 110, the third-party computing system 120, and the user device 130 can be in communication with each other and connected by a network 101.

The network 101 can include any type or form of one or more networks. The geographical scope of the network 101 can vary widely and the network 101 can include a body area network (BAN), a personal area network (PAN), a local-area network (LAN), e.g., Intranet, a metropolitan area network (MAN), a wide area network (WAN), or the Internet. The topology of the network 101 can be of any form and can include, e.g., any of the following: point-to-point, bus, star, ring, mesh, or tree. The network 101 can include an overlay network which is virtual and sits on top of one or more layers of other networks. The network 101 can be of any such network topology as known to those ordinarily skilled in the art capable of supporting the operations described herein. The network 101 can utilize different techniques and layers or stacks of protocols, including, e.g., the Ethernet protocol, the Internet protocol suite (TCP/IP), the Asynchronous Transfer Mode technique, the SONET (Synchronous Optical Networking) protocol, or the SD (Synchronous Digital Hierarchy) protocol. The TCP/IP Internet protocol suite can include application layer, transport layer, Internet layer (including, e.g., IPv6), or the link layer. The network 101 can include a type of a broadcast network, a telecommunications network, a data communication network, or a computer network.

The provider computing system 110 is owned by, associated with, or otherwise operated by a provider institution. In some instances, the provider computing system 110 may be embodied by one or more servers, each with one or more processing circuits (e.g., processing circuit 112) having one or more processors (e.g., processor 113) configured to execute instructions stored in one or more memory devices (e.g., memory 114) to send and receive data stored in the one or more memory devices and perform other operations to implement the methods described herein associated with logic or processes shown in the figures. In some instances, the provider computing system 110 may include and/or have various other devices communicably coupled thereto, such as, for example, desktop or laptop computers (e.g., tablet computers), smartphones, wearable devices (e.g., smartwatches), and/or other suitable devices.

The provider computing system 110 is shown to include the processing circuit 112, including processor 113 and memory 114. The processing circuit 112 may be structured or configured to execute or implement the instructions, commands, and/or control processes described herein with respect to the processor 113 and memory 114.

The processing circuit 112 is shown to include processor 113. The processor 113 may be implemented or performed with a general-purpose single- or multi-chip processor, a digital signal processor (DSP), an application specific integrated circuit (ASIC), one or more field programmable gate arrays (FPGAs), or other suitable electronic processing components. A general-purpose processor may be a microprocessor, or, any conventional processor, or state machine. A processor also may be implemented as a combination of computing devices, such as a combination of a DSP and a microprocessor, a plurality of microprocessors, one or more microprocessors in conjunction with a DSP core, or any other such configuration. In some embodiments, the processor 113 may be shared by multiple circuits (e.g., the circuits of the processor 113 may include or otherwise share the same processor which, in some example embodiments, may execute instructions stored, or otherwise accessed, via different areas of the memory 114). Alternatively or additionally, the processor 113 may be structured to perform or otherwise execute certain operations independent of one or more co-processors. In other example embodiments, two or more processors may be coupled via a bus to enable independent, parallel, pipelined, or multi-threaded instruction execution. All such variations are intended to fall within the scope of the present disclosure.

The processing circuit 112 is also shown to include memory 114. The memory 114 (e.g., memory, memory unit, storage device, etc.) may include one or more devices (e.g., RAM, ROM, Flash memory, hard disk storage, etc.) for storing data and/or computer code for completing or facilitating the processes, layers, and modules described in the present application. The memory 114 may be or include tangible, non-transient volatile memory or non-volatile memory. The memory 114 may also include database components, object code components, script components, or any other type of information structure for supporting the activities and information structures described in the present application.

In some embodiments, data associated with the systems described herein and used or created during the methods described herein will be stored using a distributed cache. The systems may not include in-process cache to reduce memory consumption of the systems.

As shown in FIG. 1, the provider computing system 110 may include a large language model (LLM) 115. The LLM 115 refers to a pretrained natural language model (e.g., BERT, GPT, etc.) configured to rely on learned embeddings to convert text into a numerical representation that may be understandable and usable by the LLM 115. For instance, the LLM 115 may be a sentence-embedding model (e.g., Sentence-BERT) that is specifically configured to perform a similarity search. Additionally or alternatively, the LLM 115 may be a sentence model such as the Universal Sentence Encoder. In an example implementation, the LLM 115 may be configured to convert a word into a 10-dimensional vector. This set of 10 numbers may represent some semantic meaning that the model has learned in association with that word. Furthermore, and as described in greater detail below, other words that are similar to that word may have embedding vectors that are close together in multi-dimensional space. As such, the LLM 115 may be used to provide semantic-based search term suggestions (e.g., recommended search terms 160) based on a user query.

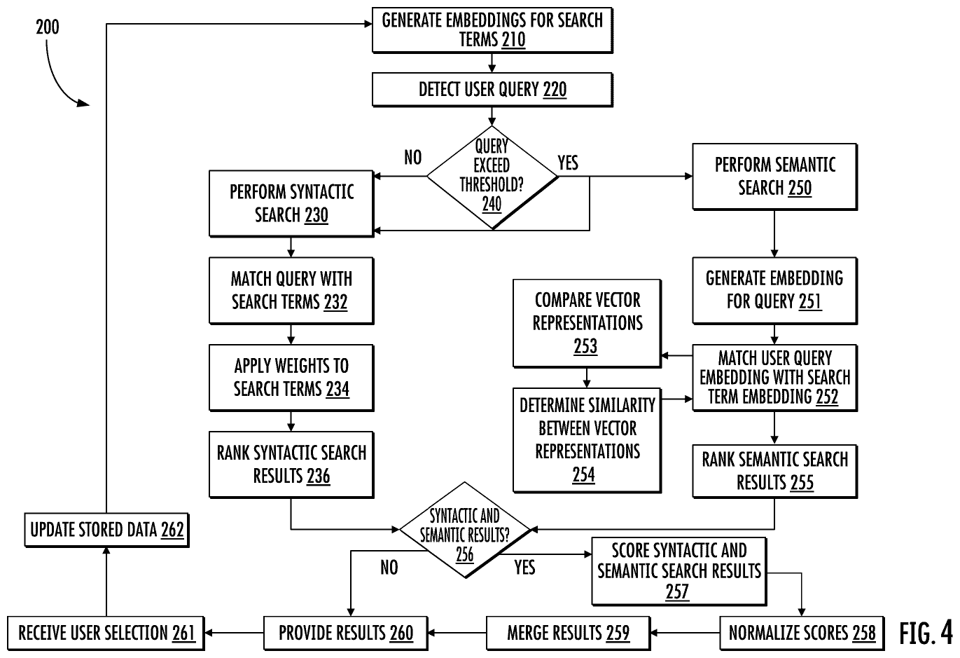

In some embodiments, the provider computing system 110 includes a network interface circuit 116 and a database 117. In some instances, the network interface circuit 116 includes, for example, program logic that connects the provider computing system 110 to the network 101. For example, in some instances, the program logic interfaces with one or more transceivers (e.g., Bluetooth, Wi-Fi, or any other suitable communication transceivers) to enable connection with the network 101. The network interface circuit 116 facilitates secure communications between the provider computing system 110, the third-party computing system 120, and the user device 130. The network interface circuit 116 further includes user interface program logic configured to generate and present web pages to users accessing the provider computing system 110 over the network 101 (e.g., user interface 150, as shown in FIG. 4).

The database 117 may include a plurality of search terms 118. In some embodiments, the search terms 118 can relate to home care services or products. For example, the search terms 118 can relate to cleaning services or products, plumbing services or products, lawn care services or products, electrical services or products, or painting services or products, among others. The search terms 118 may include a plurality of service categories (e.g., 500 service categories, etc.) that a professional service provider (e.g., a contractor, a plumber, a handyman, an electrician, etc.) may perform. Furthermore, the search terms 118 may include a plurality of search entities (e.g., 10,000 or more search entities). The search entities relate to one or more of the service categories. In this way, each service category has a plurality of corresponding search entities associated therewith. In some instances, the search entities may be paraphrases or sub-categories of the service category associated therewith. For example, the category of “Lawn Mowing” may have the search entity “Lawn Care” associated therewith.

Furthermore, the search terms 118 stored in the database 117 may be facets of the service category associated therewith. For example, “3bhk house cleaning” may be a search entity that is associated with the service category of “House Cleaning” and that corresponds to a selection from search filters or request form input fields. That is, in this example, the user may apply a search filter configured to specify “How many bedrooms?” and including options such as one bedroom, two bedrooms, three bedrooms, etc. Therefore, the search entities may include “1bhk house cleaning,” “2bhk house cleaning,” 3bhk house cleaning,” etc., such that a user query of “house cleaning” having a search filter that specifies the number of bedrooms in the house may yield an appropriate search entity.

When a user types a query into a search field, the provider computing system 110 provides search suggestions (e.g., recommended search terms 160). The recommended search terms 160 are search terms 118 stored in the database 117 that have been determined to be relevant to a user's query. The search terms 118 can be service categories and/or service entities. For example, a search query may recite “faucet leaking.” The recommended search terms 160 may include the service category of “plumbing” and/or the service entity or sub-category of “sink repair.”

The database 117 may also store historic information regarding user interactions with the search terms 118 (e.g., user interactions 119). For instance, as users select search terms 118 from the recommended search terms 160 provided on a search bar, the provider computing system 110 may store statistics relating to the raw user query that was typed by the user into the search bar and how often users select a given search term 118, how often the users select the service category associated with the given search term 118, how often a given search term 118 (e.g., service entity, service category, etc.) results in the user creating a project, etc. As such, the provider computing system 110 may use the historic information regarding user interactions 119 with the search terms 118 to select and order the recommended search terms 160 displayed in the search bar. For example, and as described below with reference to steps 234 and 236 of method 200, the popularity of a search term 118 (e.g., a number of times a user has selected the search term 118) may be used to influence the order of search terms 118 provided in the search bar.

In some embodiments, the computing environment 100 may include one or more third-party computing systems 120. The third-party computing system 120 may refer to a computing system that is external to the provider computing system 110. In some embodiments, the computing environment 100 may include a plurality of third-party computing systems 120 associated with a plurality of third-party entities. The third-party entity refers to another entity that is a third-party relative to the provider institution. In some embodiments, the entity associated with the third-party computing system 120 may be an entity configured to generate embeddings or house the LLM 115, as described herein.

The third-party computing system 120 may include the network interface circuit 122, which may be similar/identical to the network interface circuit 116 of the provider computing system 110, as described above. For example, the network interface circuit 122 includes program logic and various devices (e.g., transceivers, etc.) that connect the third-party computing system 120 to the network 101. In some instances, the program logic interfaces with one or more transceivers (e.g., Bluetooth, Wi-Fi, or any other suitable communication transceivers) to enable connection with the network 101. The network interface circuit 122 facilitates secure communications between the third-party computing system 120 and the provider computing system 110. The network interface circuit 122 also facilitates communication with other entities, such as the user device 130, etc.

In some embodiments, and as shown in FIG. 1, the third-party computing system 120 includes at least one processing circuit 124 and at least one database 126. The processing circuit 124 may be configured to perform operations associated with the third-party computing system, and may include one or more processors or memory devices, which may be similar/identical to the processor 113 or memory 114, respectively, of the provider computing system 110. Similarly, the database 126 may be configured to store information generated by or otherwise associated with the third-party computing system 120. For example, the database 126 may be configured to store a plurality of embeddings corresponding to the search terms 118, as described herein.

The user device 130 is owned, operated, controlled, managed, and/or otherwise associated with a user. The user refers to a consumer who is searching for a service via the provider computing system 110. In some embodiments, the user device 130 may be or may include, for example, a desktop or laptop computer, a smartphone, a tablet computer, a wearable device (e.g., a smartwatch), a personal digital assistant, and/or any other suitable computing device.

In some embodiments, the user device 130 includes at least one I/O device 132, at least one location sensor 134, at least one network interface circuit 136, and at least one provider application 138. While the term “I/O” is used, it should be understood that the I/O device 132 may be input-only devices, output-only devices, and/or a combination of input and output devices. In some instances, the I/O device 132 includes various devices that provide perceptible outputs (such as display devices with display screens and/or light sources for visually-perceptible elements, an audio speaker for audible elements, and haptics or vibration devices for perceptible signaling via touch, etc.), that capture ambient sights and sounds (such as digital cameras, microphones, etc.), and/or that allow the user to provide inputs (such as a touchscreen display, stylus, keyboard, force sensor for sensing pressure on a display screen, etc.). In some instances, the I/O device 132 further includes at least one user interface (e.g., devices or components that interface with the user), which may include one or more biometric sensors (e.g., a fingerprint reader, a heart monitor that detects cardiovascular signals, face scanner, an iris scanner, etc.). The location sensor 134 may be a GPS device used to determine a location of the user device 130.

The network interface circuit 136 includes, for example, program logic and various devices (e.g., transceivers, etc.) that connect the user device 130 to the network 101. The network interface circuit 136 facilitates secure communications between the user device 130 and each of the provider computing system 110 and the third-party computing system 120. The network interface circuit 136 also facilitates communication with other entities, such as other banks, settlement systems, and so on.

The user device 130 stores in computer memory, and executes (“runs”) using one or more processors, various provider applications 138 configured to enable various functionalities. In some instances, the provider applications 138 include various Internet browser applications presenting websites and/or applications provided by other entities. In some embodiments, the provider applications 138 may include a provider client application associated with the provider computing system 110.

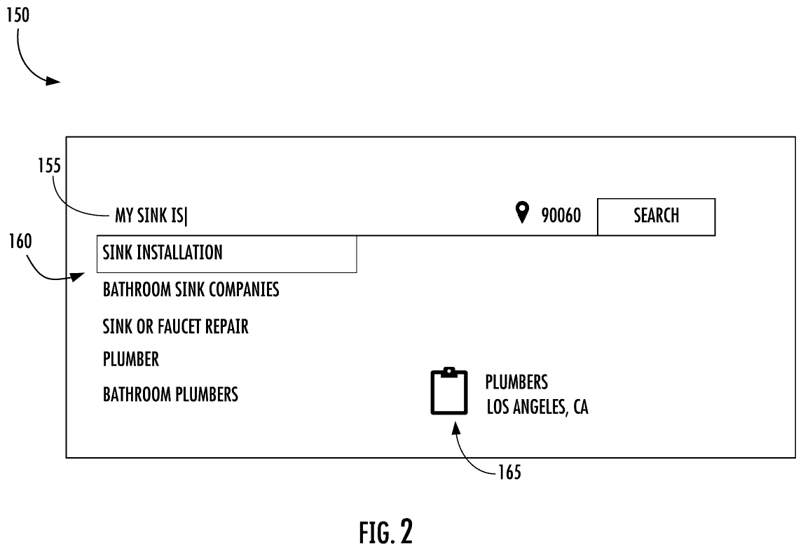

Referring to FIG. 2, a user interface 150 configured to present syntactic-based and semantic-based search term recommendations to a user is shown, according to an example embodiment. The user interface 150 may be generated by the provider computing system 110 for display on the user device 130. In some embodiments, the user interface 150 is generated by the provider application 138. In some embodiments, the user interface 150 may be displayed to a user during a session with the provider application 138. The session with the provider application 138 may refer to an engagement or interaction with the provider application 138. That is, the session may begin when a user successfully accesses the provider application 138 and initiates a user query. The session may end when a user exits/logs out of/closes the provider application 138.

More specifically, the user interface 150 is shown to include a user query 155. The user query 155 may be the user query detected at step 220 of method 200, as described below. As an example, the user query 155 shown in FIG. 2 is “my sink is.” Furthermore, in some instances, a user may submit the user query 155 with a corresponding geographic area. For example, the user query 155 is shown in FIG. 2 with the zip code 90060 (e.g., Los Angeles). In this way, the results to the user query 155 may be filtered such that the results correspond to a location that is within or proximate to the zip code 90060.

Furthermore, based on the user query 155, the user interface 150 is shown to include a plurality of recommended search terms 160. The recommended search terms 160 may be the results provided at step 260 of method 200, as described below. For instance, in response to the user query 155 being “my sink is,” the plurality of recommended search terms 160 may include “sink installation,” “bathroom sink companies,” “sink or faucet repair,” “plumber,” and “bathroom plumbers.” As shown in FIG. 2, the plurality of recommended search terms 160 may include syntactic results (e.g., generated during a syntactic search) based on the user query 155 and semantic results (e.g., generated during the semantic search) based on the user query 155. For example, based on the user query 155 being “my sink is,” the syntactic results can include “sink installation,” “bathroom sink companies,” and “sink or faucet repair,” while the semantic results can include “plumber” and “bathroom plumbers.” The recommended search terms 160 may be retrieved from the plurality of search terms stored in the database 117, as described above.

In some instances, the user interface 150 may suggest a service category 165 to the user based on the user query 155. For instance, based on the user query 155 being “my sink is,” the service category 165 provided in response may be plumbers. Furthermore, where the user query 155 includes a geographical location (e.g., Los Angeles), the service category 165 may specify services within that geographical location (e.g., plumbers within Los Angeles). The service category 165 may be one of the plurality of search terms stored in the database 117. Furthermore, each of the recommended search terms 160 may be associated with the service category 165.

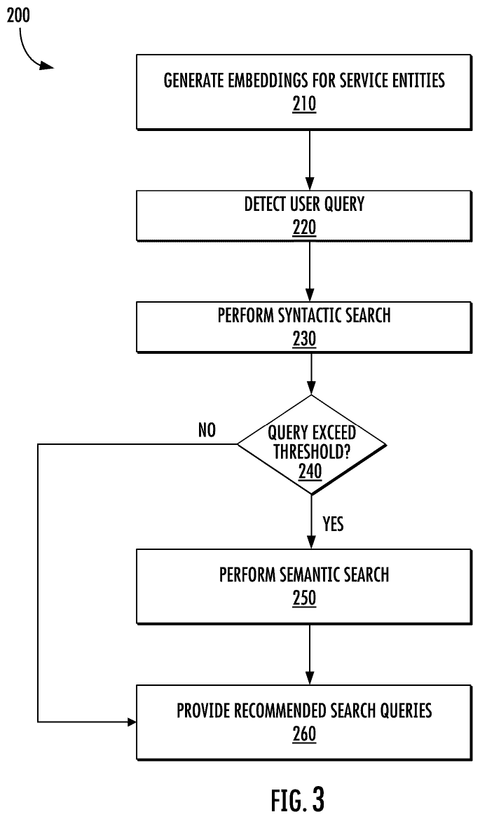

Referring to FIG. 3, a flow chart illustrating a method 200 for providing recommended search terms using syntactic and semantic guidance is shown, according to an example embodiment. Various operations of the method 200 may be conducted by the computing environment 100 and particularly parts thereof (e.g., the provider computing system 110, the third-party computing system 120, the user device 130). It should be understood that not all method steps/processes may be performed to “complete” the method. Certain steps/processes may be omitted in other embodiments, and still fall within the scope of the present disclosure.

At step 210, method 200 includes generating embeddings for search terms. More specially, step 210 includes generating, using a large language model (e.g., LLM 115), a plurality of embeddings corresponding to the search terms 118. That is, the LLM 115 may be used to precompute and store (e.g., with the search terms 118 in the database 117) embeddings for the search terms 118 (e.g., search entities, service categories, etc.). In some embodiments, the embeddings are or include vector representations corresponding to the search terms 118 that can be analyzed in a multi-dimensional space. In some embodiments, the embeddings may be generated offline and may be stored in the database 117 such that they are accessible online.

At step 220, a user query is detected. That is, step 220 may include detecting that a user has initiated a query in response to the user entering one or more characters into a search field. For example, the user query detected at step 220 may refer to the user query 155 shown in FIG. 4.

At step 230, method 200 includes performing a syntactic search. More specifically, and as described in greater detail below with reference to FIG. 4, the syntactic search performed at step 230 includes identifying a plurality of prefix match results based on the one or more characters included in the user query detected at step 220.

As shown in FIG. 3, method 200 includes determining whether the user query detected at step 220 exceeds a query threshold (e.g., threshold length) at step 240. In some instances, the query threshold may include a character count of the characters included in the user query detected at step 220 (e.g., five characters, ten characters, etc.). Additionally or alternatively, the threshold query may include a word count of words included in the user query detected at step 220 (e.g., one word, two words, etc.). In this way, semantic searching (e.g., performed at step 250) may not be triggered until a threshold number of characters are entered into a search bar.

This determination is made at step 240 in real-time with respect to when the user query (e.g., detected at step 220) is entered. In this way, a first determination made at step 240 may be that the user query does not exceed the threshold length. As the user types more characters into the search field, however, a second determination made at step 240 may be that the user query does exceed the threshold length. As an example, if a user types in “fix,” step 240 may include determining that the user query (e.g., “fix”) does not exceed the threshold length. As soon as the user types in “fix garage,” however, step 240 may include determining that the user query (e.g., “fix garage”) does exceed the threshold length. In some embodiments, a determination at step 240 can be made for every keystroke that is made (e.g., every additional character added to or removed from the user query initiates a new determination of whether the threshold is met). In some embodiments, a keystroke threshold and/or a time threshold can be applied to determine when to initiate step 240. For example, a new determination of whether the threshold length has been met can be made every predetermined number of keystrokes (e.g., recalculate threshold length after 5 keystrokes, etc.). As another example, a new determination of whether the threshold length has been met can be made after a predetermined amount of time (e.g., recalculate threshold length after 5 seconds, etc.). Other limits and thresholds can be applied to step 240 to reduce the number of computations being performed and amount of computational energy being used.

If the user query does exceed the threshold length, as determined at step 240, method 200 continues with performing a semantic search at step 250. As described in greater detail below with reference to FIG. 4, performing the semantic search may include generating an embedding for the user query and matching the embedding for the user query to a subset of the embeddings for the search terms 118 generated at step 210.

In such instances where the user query does exceed the threshold length, recommended search terms 160 are provided at step 260 after the semantic search is performed at step 250. As described below with reference to FIG. 4, the recommended search terms 160 are provided by merging the results from the syntactic search and the semantic search. The selected recommended search terms 160 are selected based on a ranking of the syntactic search results (e.g., prefix match results generated during the syntactic search performed at step 230) and the semantic search results (e.g., identified during the semantic search performed at step 250). For example, once the threshold number of characters are entered into the search bar, syntactic and semantic searching may be combined based on corresponding weights (e.g., as described in greater detail below with reference to FIG. 4). As a more specific example, semantic searching may progressively become more heavily weighted as more characters beyond the threshold number of characters are entered. For example, the recommended search terms 160 include a number of prefix match results and a number of semantic search results. The number of each result can be based on the query length. For example, the number of semantic search results in the recommended search terms 160 can increase and the number of prefix match results in the recommended search terms 160 can decrease as a number of characters in the user query increases.

As an illustrative example, if the threshold number of characters is 5 characters, the semantic searching may be weighted more heavily when seven characters are entered into the search query than when six characters are entered into the search query. More specifically, the recommended search terms may change from being 100% prefix match results when the user query includes one to four characters, to being 25% semantic results (e.g., from the LLM 115) when the user query includes five characters, to being 50% semantic results when the user query includes six characters, to be 75% semantic results when the user query includes seven or more characters, and so on.

If the user query is below the threshold, as determined at step 240, method 200 continues with providing recommended search terms 160 at step 260. In this case, method 200 does not include performing the semantic search at step 250 and the recommended search terms 160 includes only the prefix matching results.

Referring to FIG. 4, the method 200 for providing recommended search terms 160 using syntactic and semantic guidance is shown in greater detail. As shown in FIG. 4, after generating the embeddings for the search terms at step 210 and detecting the user query at step 220, method 200 continues with performing the syntactic search at step 230 and determining whether the user query exceeds the threshold at step 240.

In some instances, performing the syntactic search at step 230 includes matching the user query with search terms at step 232.

Furthermore, performing the syntactic search at step 230 may include applying weights to the search terms at step 234. In some instances, the weights applied to the search terms are modified based on a popularity of the search terms. In some examples, the popularity may be modeled to account for the impact of the number of times a search entity is selected. Additionally or alternatively, the popularity may be modeled using other criteria such as advanced user interaction beyond an initial selection (e.g., contacting a professional associated with a selected search entity). In one example, the equation used to calculate weights of the search terms is:

$$searchEntityWeight = {w}_{searches} * {X}_{searches} + {w}_{contacts} * {X}_{contacts}$$

where w_{searches} and w_{contacts} are the weights applied at step 234. More specifically, w_{searches} refers to the weight of searches as a metric, and w_{contacts} refers to the weight of contacts as a metric. In some instances,

$${w}_{searches} = \frac{1}{7} and {w}_{contacts} = \frac{6}{7} .$$

Furthermore, X_{searches} and X_{contacts} are terms that may represent how the search entity metric contribution is weighted relative to the category level metric's contribution.

Turning to X_{searches}, as mentioned above with reference to the database 117, each of the search entities may correspond to a specific service category. As such, the weights applied at step 234 may be configured to weigh a popularity of the search entity individually (e.g., based on a number of searches for an individual search entity), or to weigh a popularity of a service category to which the search entities correspond (e.g., based on a number of searches for a service category overall). In this way, X_{searches} may be defined as

$${X}_{searches} = {w}_{se} * {normalizedAndScaledSearches}_{se} + {w}_{cat} * {normalizedAndScaledSearches}_{cat}$$

where wₛₑ and w_{cat} represent the weight applied to the search entity level metrics versus the category level metrics, respectively. Furthermore,

$${w}_{se} = \frac{4}{5} , and {w}_{cat} = \frac{1}{5} .$$

In some instances, normalizedAndScaledSearchesₛₑ is the normalized search entity level value for searches scaled to fall within the range [1, 10]. Similarly, normalized AndScaledSearches_{cat} may be the normalized category level value for searches scaled to fall within the range [1, 10].

Similarly, X_{contacts} may be used to account for business metrics (e.g., a number of contact) when applying weights to search terms at step 234. More specifically, the number of contacts may be based on an individual search entity or may be based on a number of search entities associated with a specific service category. In an example embodiment, X_{contacts} may be defined as

$${X}_{contacts} = {w}_{se} * {normalizedAndScaledContacts}_{se} + {w}_{cat} * {normalizedAndScaledContacts}_{cat}$$

where wₛₑ and w_{cat} represent the weight applied to the search entity level metrics versus the category level metrics, respectively. As stated above,

$${w}_{se} = \frac{4}{5} , and {w}_{cat} = \frac{1}{5} .$$

In some instances, normalizedAndScaledContactsₛₑ is the normalized search entity level value for contacts scaled to fall within the range [1, 10]. Similarly, normalizedAndScaledContacts_{cat} may be the normalized category level value for searches scaled to fall within the range [1, 10].

As such, the computing environment 100 can dynamically update how the recommended search terms 160 are selected based on updated user interactions. For example, users may input a user query that corresponds to both a first subset of search terms 118 and a second subset of search terms 118. At a first time, users may select the first subset of search terms 118 more frequently than the second subset of search terms 118. Accordingly, the recommended search terms 160 during the first time may include the first subset of search terms 118 more than the second subset of search terms 118. However, during a second time, the trend may shift where the users are selecting the second subset of search terms 118 more frequently than the first subset. Accordingly, the computing environment 100 can adjust the recommended search terms 160 to include the second subset of search terms 118.

At step 236, the search terms may be ranked based on the weights applied at step 234. For example, and as mentioned above, the popularity of a search entity term (e.g., a number of times a user has selected the search entity term) may be used to influence the order of search terms 118 provided in the search bar. Once the search terms 118 are ranked at step 236, syntactic search results are scored at step 238.

As described above with reference to FIG. 3, in instances during which the user query exceeds the threshold, as determined at step 240, the method 200 includes performing the semantic search at step 250. Semantic searching beneficially serves users by understanding the user's intent in the context of the search space. More specifically, performing the semantic search at step 250 may include understanding what the user is searching for and redirecting the user to an appropriate list of service professionals. For example, if a user enters “stove fixer” as a search query, the semantic search performed at step 250 may yield results such as “Appliance Repair,” “Electric Stove Repair,” “Handyman,” etc. Furthermore, in response to a user submitting the search query of “stove fixer,” the provider computing system 110 may be configured to redirect the user to a list of appliance repair specialists filtered for the “over or stove” appliance type.

In some examples, embeddings may be used to facilitate the sematic search. Therefore, as shown in FIG. 4, performing the semantic search at step 250 may include generating embeddings for the user query at step 251. As an overview, embeddings facilitate mapping high-dimensional data into manageable low-dimensional space. More specifically, embeddings may be common numeric vectors that represent and quantify complex data, such as text (e.g., text included in a search query). Using embeddings to represent complex data reduces computational complexity of processing large datasets without losing the information corresponding to the datasets. Using embeddings allows the computing environment 100 to process large quantities of data (e.g., long search queries) while minimizing consumption of computational power. Further, the computing environment 100 is able to receive and analyze data in various formats (e.g. text, images, graphs, etc.) by converting the data into embeddings that can be compared to each other. As described above with reference to FIG. 1, the embeddings may be generated by the LLM 115. Furthermore, as described herein, using embeddings to perform the semantic search at step 250 beneficially allows users to type in any free text and thereafter be redirected to a relevant search term professional list. As yet another benefit, using the embeddings incorporates the advantages of modern natural language models in accurately deriving a semantic meaning from text.

The embeddings for the user query generated at step 251 are matched to embeddings for search terms at step 252. More specifically, matching the embeddings can include comparing at least one user query vector representation corresponding to a user query embedding to a plurality of search term vector representations corresponding to a subset of search term embeddings at step 253. At step 254, a similarity function (e.g., cosine similarity, K-nearest neighbors, etc.) is performed to identify search term vector representations that are closest to the user query vector representation. More specifically, the search term vector representations may be identified because they are a smallest distance apart from the user query vector representations. Cosine similarities can be based on a distance between the user query vector representation and the various search entity vector representations. For example, the provider computing system 110 can determine a distance (e.g., a cosine distance) between the user query vector representation and a search term vector representation. A smaller distance between the user query vector representation and a search entity vector representation correlates to a greater cosine similarity. In this way, the similarity function is configured to provide search terms that are semantically similar to the user query that was typed in by the user. The semantic search results include the search terms that are identified as being the most similar to the user query based on the similarity function.

As shown in FIG. 4, method 200 continues with ranking the semantic search results at step 255. In some embodiments, the semantic search results are ranked based on the cosine similarity between the corresponding vectors. For example, a first search term can have a first cosine similarity and a second search term can have a second cosine similarity. The first cosine similarity can be greater than the second cosine similarity. Accordingly, the first search term can be ranked higher than the second search term.

In some embodiments, rankings of the semantic search results can be based on previous user queries 155. For example, a user may provide a first user query and receive a first set of recommended search terms 160. If the user does not think the first set of recommended search terms 160 includes the appropriate search term 118, the user may erase the first user query and input a second user query. The first user query can still be used to provide context for creating a second set of recommended search terms 160. In other embodiments, the first user query can be erased such that the second user query is not affected by the first user query.

Step 256 includes determining whether there are syntactic search results and semantic search results to provide to the user. If there are not both syntactic and semantic search results (e.g., there are only syntactic search results since the user query did not meet the query threshold), method 200 proceeds with providing the ranked syntactic results at step 260. As such, steps 257-259 as described below can be skipped since there are no semantic results to compare with the syntactic results. Skipping such steps can reduce the computing power consumed to provide the search results to the user.

If there are both syntactic and semantic search results (e.g., a semantic search was performed simultaneously with the syntactic search based on the query exceeding the query threshold), method 200 includes scoring the syntactic and semantic search results at step 257. In some embodiments, scoring the syntactic search results may be based on the weights applied to the search terms during the syntactic search. Scoring the semantic search results may be based on the cosine similarities of the search terms determined during the semantic search.

At step 258, the scores of the syntactic and semantic search results can be normalized. For example, the search results can be normalized on a 0-1 scale. In some embodiments, the syntactic search results can be normalized according to a [0, 1] search term weight. In some embodiments, the semantic search results can be normalized according to a [0, 1] cosine similarity score. Once the scores are normalized at step 258, the results from each search are merged at step 259 to create the list of recommended search terms 160. For example, a merging algorithm can be applied to the search results from both searches and the recommended search terms 160 can include a subset of the prefix match results from the syntactic search and a subset of the search terms identified from the semantic search. When merged, the results can be ranked and ordered according to the normalized scores. Merging can include determining a number of search terms to be selected from each search. For example, the number of results taken from each search can be based on the user query 155. For example, the length of the user query 155 can determine how may results from each search are used. As described above, a longer user query 155 can correspond to more semantic search results and fewer syntactic search results being used in the final recommended search terms 160. After merging the results from the two searches, the recommended search terms 160 are then provided to the user at step 260.

In some embodiments, merging the search results can include removing duplicates from the recommended search terms 160. For example, step 259 can include determining a prefix match result matches a search term from the semantic search (e.g., both searches identified the same search term that matches the user query). Responsive to such determination, one of the prefix match result or the search term from the semantic search is removed from the recommended search terms 160 (e.g., to eliminate duplicate recommended search terms 160).

In some embodiments, merging the results can include removing or ignoring previous user queries. For example, in some embodiments, recommended search terms 160 can be ranked.

In some embodiments, method 200 can end after the ranked search results are provided at step 260. In some embodiments, method 200 can continue to receive and analyze user data to dynamically update the data in the system to provide better search results to the user for future user queries. For example, method 200 can include receiving a user selection of one of the provided search results at step 261. For example, a user may determine that one of the search results provided at step 260 correlates best with their search query. Responsive to receipt of the user selection, method 200 can proceed to update data stored in the provider computing system 110 and/or the third-party computing system 120 at step 262. The stored data can include, for example, user interaction 119, search term weights, or search term embeddings. For example, the provider computing system 110 can update the user interactions 119 stored in the database 117, update the weights applied to search terms during the syntactic search, and/or update embeddings corresponding to the search terms. Using downstream user interactions to update the data stored in the systems 110, 120 allows the systems 110, 120 to make better correlations between user queries and stored search terms that reflect the actual desires of the user.

It should be understood that no claim element herein is to be construed under the provisions of 35 U.S.C. § 112(f), unless the element is expressly recited using the phrase “means for.”

As utilized herein, terms of degree such as “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to any precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that terms such as “exemplary,” “example,” and similar terms, as used herein to describe various embodiments, are intended to indicate that such embodiments are possible examples, representations, or illustrations of possible embodiments, and such terms are not intended to connote that such embodiments are necessarily extraordinary or superlative examples.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

The term “or,” as used herein, is used in its inclusive sense (and not in its exclusive sense) so that when used to connect a list of elements, the term “or” means one, some, or all of the elements in the list. Conjunctive language such as the phrase “at least one of X, Y, and Z,” unless specifically stated otherwise, is understood to convey that an element may be either X, Y, Z; X and Y; X and Z; Y and Z; or X, Y, and Z (i.e., any element on its own or any combination of X, Y, and Z). Thus, such conjunctive language is not generally intended to imply that certain embodiments require at least one of X, at least one of Y, and at least one of Z to each be present, unless otherwise indicated.

References herein to the positions of elements (e.g., “top,” “bottom,” “above,” “below”) are merely used to describe the orientation of various elements in the drawings. It should be noted that the orientation of various elements may differ according to other exemplary embodiments, and that such variations are intended to be encompassed by the present disclosure.

As used herein, terms such as “engine” or “circuit” may include hardware and machine-readable media storing instructions thereon for configuring the hardware to execute the functions described herein. The engine or circuit may be embodied as one or more circuitry components including, but not limited to, processing circuitry, network interfaces, peripheral devices, input devices, output devices, sensors, etc. In some embodiments, the engine or circuit may take the form of one or more analog circuits, electronic circuits (e.g., integrated circuits (IC), discrete circuits, system on a chip (SOCs) circuits, etc.), telecommunication circuits, hybrid circuits, and any other type of circuit. In this regard, the engine or circuit may include any type of component for accomplishing or facilitating achievement of the operations described herein. For example, an engine or circuit as described herein may include one or more transistors, logic gates (e.g., NAND, AND, NOR, OR, XOR, NOT, XNOR, etc.), resistors, multiplexers, registers, capacitors, inductors, diodes, wiring, and so on).

An engine or circuit may be embodied as one or more processing circuits comprising one or more processors communicatively coupled to one or more memory or memory devices. In this regard, the one or more processors may execute instructions stored in the memory or may execute instructions otherwise accessible to the one or more processors. The one or more processors may be constructed in a manner sufficient to perform at least the operations described herein. In some embodiments, the one or more processors may be shared by multiple engines or circuits (e.g., engine A and engine B, or circuit A and circuit B, may comprise or otherwise share the same processor which, in some example embodiments, may execute instructions stored, or otherwise accessed, via different areas of memory).

Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be provided as one or more suitable processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor, etc.), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given engine or circuit or components thereof may be disposed locally (e.g., as part of a local server, a local computing system, etc.) or remotely (e.g., as part of a remote server such as a cloud based server). To that end, engines or circuits as described herein may include components that are distributed across one or more locations.

An example system for providing the overall system or portions of the embodiments described herein might include one or more computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR, etc.), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components, etc.), in accordance with the example embodiments described herein.

Although the drawings may show and the description may describe a specific order and composition of method steps, the order of such steps may differ from what is depicted and described. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions, and arrangement of the embodiments without departing from the scope of the present disclosure as expressed in the appended claims.

What is claimed is:

1. A computing system comprising:
a processing circuit having one or more processors coupled to one or more memory devices storing instructions thereon that, when executed by the one or more processors, cause the processing circuit to perform operations comprising:
generating, using a large language model, a plurality of embeddings corresponding to a plurality of search terms;
detecting an initiation of a user query, wherein the user query comprises one or more characters;
performing a syntactic search, wherein the syntactic search comprises identifying a plurality of prefix match results based on the one or more characters included in the user query;
determining, in real-time with respect to the user query being entered, that the user query exceeds a threshold length;
in response to determining that the user query exceeds the threshold length, performing a semantic search, the semantic search comprising:
generating at least one embedding for the user query; and
matching the at least one embedding for the user query to a subset of the plurality of embeddings, wherein the subset of the plurality of embeddings correspond to a subset of the plurality of search terms; and
providing a plurality of recommended search terms, wherein the plurality of recommended search terms are provided based on a ranking of the plurality of prefix match results and the subset of the plurality of search terms.

2. The computing system of claim 1, wherein in response to determining that the user query is below a threshold length, the semantic search is not performed.

3. The computing system of claim 1, wherein the threshold length comprises a character count of the one or more characters included in the user query.

4. The computing system of claim 1, wherein:
the at least one embedding corresponds to at least one user query vector representation;
the plurality of embeddings correspond to a plurality of search entity vector representations, and
matching the at least one embedding for the user query to the subset of the plurality of embeddings comprises determining a plurality of cosine similarities between the at least one user query vector representation and the plurality of search entity vector representations.

5. The computing system of claim 4, wherein the subset of the plurality of search terms are ranked according to the plurality of cosine similarities, the plurality of cosine similarities being based on distances between the at least one user query vector representation and the plurality of search entity vector representations, wherein a smaller distance between the at least one user query vector representation and one of the plurality of search entity vector representations correlates to a greater cosine similarity.

6. The computing system of claim 1, wherein the syntactic search further comprises applying weights to the plurality of prefix match results.

7. The computing system of claim 6, wherein the weights are based on a popularity of the plurality of prefix match results, wherein the popularity is based on historical user interaction with the plurality of prefix match results.

8. The computing system of claim 1, wherein the plurality of recommended search terms include a number of prefix match results and a number of semantic search results, wherein the number of semantic search results increases and the number of prefix match results decreases as a number of characters in the user query increases.

9. The computing system of claim 1, wherein the plurality of search terms comprises a plurality of service categories and a plurality of service entities, wherein each of the plurality of service entities corresponds to at least one of the plurality of service categories.

10. The computing system of claim 1, wherein the instructions cause the processing circuit to perform operations comprising:
determining a prefix match result matches a search term from the subset of the plurality of search terms; and
responsive to determining the prefix match result matches the search term, removing one of the prefix match result or the search term from the plurality of recommended search terms.

11. The computing system of claim 1, wherein providing the plurality of recommended search terms further comprises:
scoring each of the plurality of prefix match results and the subset of the plurality of search terms; and
ordering each of the plurality of prefix match results and the subset of the plurality of search terms based on the scoring.

12. A method comprising:
generating, by a computing system using a large language model, a plurality of embeddings corresponding to a plurality of search terms;
detecting, by the computing system, an initiation of a user query, wherein the user query comprises one or more characters;
performing, by the computing system, a syntactic search, wherein the syntactic search comprises identifying a plurality of prefix match results based on the one or more characters included in the user query;
determining, by the computing system and in real-time with respect to the user query being entered, that the user query exceeds a threshold length;
in response to determining that the user query exceeds the threshold length, performing, by the computing system, a semantic search, the semantic search comprising:
generating at least one embedding for the user query; and
matching the at least one embedding for the user query to a subset of the plurality of embeddings, wherein the subset of the plurality of embeddings correspond to a subset of the plurality of search terms; and
providing, by the computing system, a plurality of recommended search terms, wherein the plurality of recommended search terms are provided based on a ranking of the plurality of prefix match results and the subset of the plurality of search terms.

13. The method of claim 12, wherein the threshold length comprises a character count of the one or more characters included in the user query.

14. The method of claim 12, wherein:
the at least one embedding corresponds to at least one user query vector representation;
the plurality of embeddings correspond to a plurality of search entity vector representations, and
matching the at least one embedding for the user query to the subset of the plurality of embeddings comprises determining a plurality of cosine similarities between the at least one user query vector representation and the plurality of search entity vector representations.

15. The method of claim 14, wherein the subset of the plurality of search terms are ranked according to the plurality of cosine similarities, the plurality of cosine similarities being based on distances between the at least one user query vector representation and the plurality of search entity vector representations, wherein a smaller distance between the at least one user query vector representation and one of the plurality of search entity vector representations correlates to a greater cosine similarity.

16. The method of claim 12, wherein the syntactic search further comprises applying weights to the plurality of prefix match results, and wherein the weights are based on a popularity of the plurality of prefix match results, wherein the popularity is based on historical user interaction with the plurality of prefix match results.

17. The method of claim 12, wherein the plurality of recommended search terms include a number of prefix match results and a number of semantic search results, wherein the number of semantic search results increases and the number of prefix match results decreases as a number of characters in the query increases.

18. The method of claim 12, wherein providing the plurality of recommended search terms further comprises:
scoring, by the computing system, each of the plurality of prefix match results and the subset of the plurality of search terms; and
ordering, by the computing system, each of the plurality of prefix match results and the subset of the plurality of search terms based on the scoring.

19. The method of claim 12, further comprises: wherein
determining, by the computing system, a prefix match result matches a search term from the subset of the plurality of search terms, and
responsive to identifying the prefix match result matches the search term, removing, by the computing system, one of the prefix match result or the search term from the plurality of recommended search terms.

20. A non-transitory computer-readable medium storing instructions that, when executed by one or more processors of a processing circuit, cause the processing circuit to:
generate, using a large language model, a plurality of embeddings corresponding to a plurality of search terms;
detect an initiation of a user query, wherein the user query comprises one or more characters;
perform a syntactic search, wherein the syntactic search comprises identifying a plurality of prefix match results based on the one or more characters included in the user query;
determine, in real-time with respect to the user query being entered, that the user query exceeds a threshold length;
in response to determining that the user query exceeds the threshold length, perform a semantic search, the semantic search comprising:
generating at least one embedding for the user query; and
matching the at least one embedding for the user query to a subset of the plurality of embeddings, wherein the subset of the plurality of embeddings correspond to a subset of the plurality of search terms; and
provide a plurality of recommended search terms, wherein the plurality of recommended search terms are provided based on a ranking of the plurality of prefix match results and the subset of the plurality of search terms.
